(19) United States
(12) Patent Application Publication
(10) Pub. No.: US 2010/0263451 A1
(43) Pub. Date: Oct. 21, 2010

(54) PIEZOELECTRIC PRESSURE SENSOR

(75) Inventors: Alexander Friedl, Graz (AT); Wolfgang Michelitsch, Graz (AT)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: Piezocryst Advanced Sensorics GMBH

(21) Appl. No.: 12/452,880

(22) PCT Filed: Jun. 23, 2008
(86) PCT No.: PCT/EP2008/057925

§ 371 Date: Jan. 27, 2010

(30) Foreign Application Priority Data
Jul. 27, 2007 (AT) A 1187/2007

(51) Int. Cl. G01L 9/08

(52) U.S. Cl. 73/723

(57) ABSTRACT

A piezoelectric pressure sensor which includes piezoelectric measuring elements is inserted in a housing having a membrane element located on the pressure side of the housing. The membrane element has a centered membrane stamp at the centre of a thin annular membrane. The piezoelectric measuring elements being radially disposed outwards from a prestressing element extending essentially along the longitudinal axis of the sensor, which prestressing element passes through the housing base, serves as a lead for the sensor signal and is attached to a pressure body at its end adjacent to the membrane. The centered membrane stamp is attached to the pressure body, and the prestressing element is prestressed against the housing base, having a gas-tight insulating element interposed. Furthermore, the pressure body is provided with a sealing shoulder which fits against a sealing seat in the interior of housing upon destruction of the measuring elements, thus forming a gas-tight zone.

The invention relates to a piezoelectric pressure sensor comprising piezoeelectric measuring elements inserted into a housing, and a membrane element, which is disposed on the pressure side of the housing and has a centered membrane stamp at the centre of a thin annular membrane, the piezoelectric measuring elements being radially disposed outwards from a prestressing element inserted essentially along the longitudinal axis of the sensor, which prestressing element passes through the base of the housing and serves as lead for the sensor signal and is connected to a pressure body at its end adjacent to the membrane.

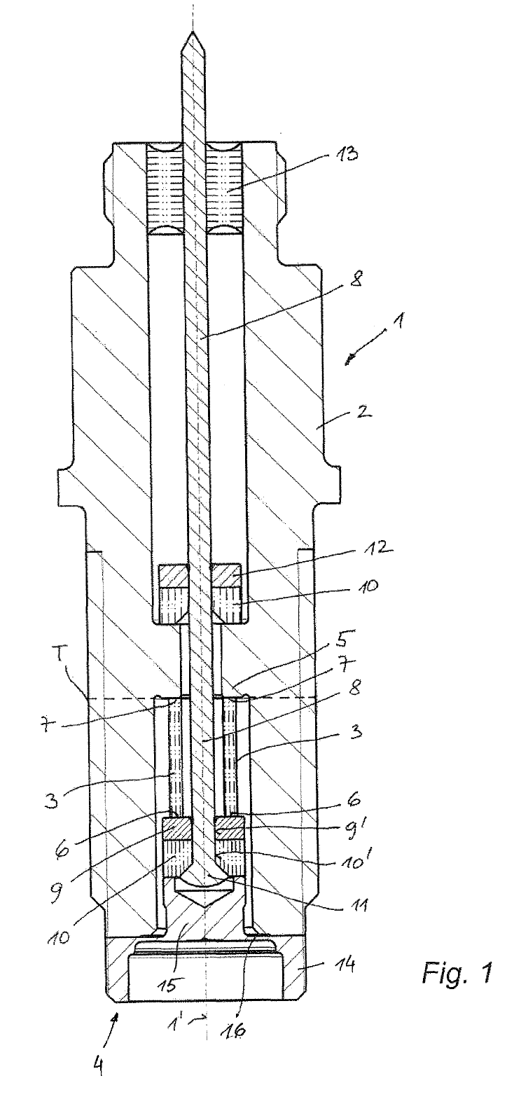

To achieve high linearity of the measurement signal piezoelectric pressure sensors require mechanical prestressing of the piezoelectric measuring elements. Prestressing can for instance be applied by a so-called tubular spring surrounding the measuring elements, i.e. enclosing them essentially in a cylindrical interior space. As for instance depicted in FIG. 1 of EP 0 745 835 A2, the tubular spring serves to reliably press together the piezoelectric measuring elements, the tubular spring itself being configured as a thin elastic cylinder of little mass. Manufacture and use of the tubular spring is costly, making an improvement desirable.

In the case of pressure sensors without cooling, prestressing may—at least for a limited period of time—be achieved through the membrane itself, which in the case of high-temperature sensors is subject to tension decay, however, due to the temperature loads occurring (temperatures greater than 400° C.), thereby causing a change in sensor sensitivity and a loss of linearity. The present invention will therefore exclusively address pressure sensors with a separate prestressing element.

From a variant of a previous patent application (A 641/2006) it is known to provide an interior prestressing element, in which the central prestressing element carries the measurement signal and the measuring elements are radially disposed on the outside of the prestressing element. An embodiment of this kind according to the state of the art will subsequently be described as FIG. 1.

Such pressure sensors are used for instance in permanent monitoring of internal combustion engines, and must accordingly have a long service life of up to 20,000 hours and more, in order to ensure large service intervals. The internal combustion engines are usually operated continuously to generate electrical power or heat or to power motor vehicles.

The pressure sensors mentioned use flexible membranes on the side of the combustion chamber, which may break under extremely adverse cicumstances, with parts of the membrane entering the combustion chamber and a path opening between combustion chamber and the environment. Escaping flames and pressure waves could cause great damage and danger to personnel and equipment.

It is the object of the present invention to improve known pressure sensors with interior prestressing in such a way that the pressure sensor will not be a source of danger even if the membrane breaks, and that safe operation of an engine provided with a pressure sensor will be guaranteed.

According to the invention this object is achieved by proposing that the centered membrane stamp is attached to the pressure body and that the prestressing element is prestressed against the housing base with a gas-tight insulating element being interposed.

In further enhancement of the invention the pressure body has a sealing shoulder, which upon breaking of the measuring elements presses tightly against a sealing seat inside the housing and thus establishes a gas-tight zone.

If the membrane element fails two types of failure are to be discerned:
(a) the annular membrane of the membrane element breaks, but the measuring elements are still undamaged, i.e. the prestressing element, which is supported by the measuring elements, keeps the combustion chamber sealed with the help of the gas-tight insulating element at the housing base;
(b) both the annular membrane of the membrane element and the measuring elements are destroyed, thus the prestressing element comes loose and will seal no longer, but the special shape of the pressure body with its sealing shoulder provides a seal against the sensor housing.

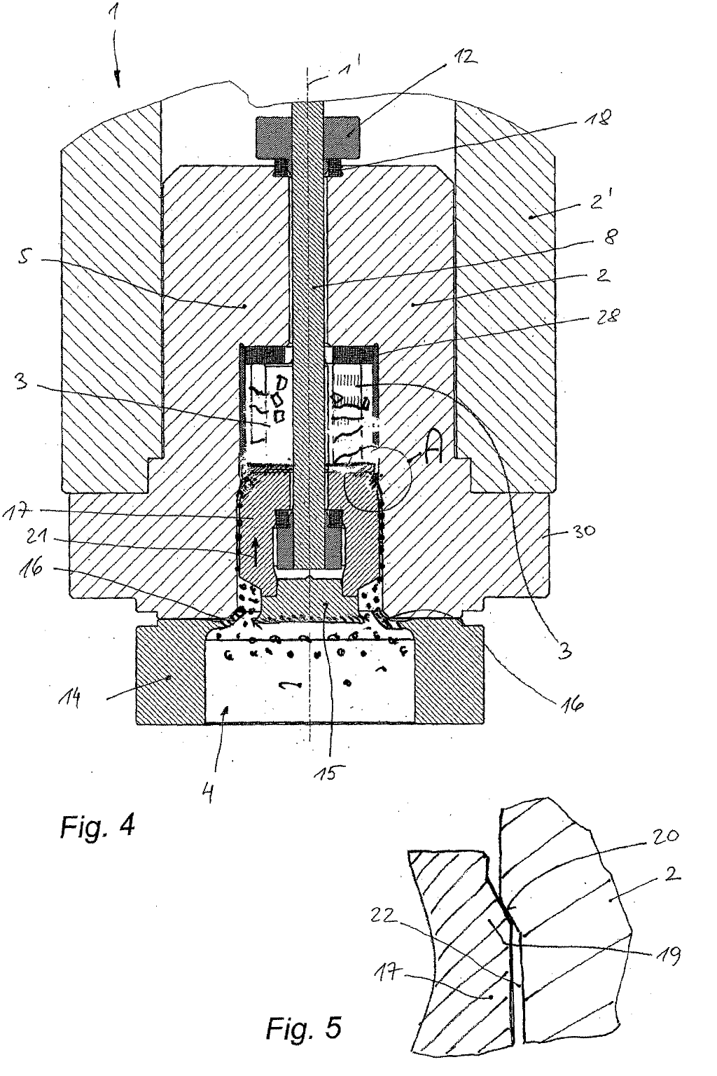

The two types of failure (a) and (b) of a breaking membrane are shown in detail in FIGS. 4 and 5. There is shown in:

FIG. 1 a piezoelectric pressure sensor according to the state of the art in an axial section;

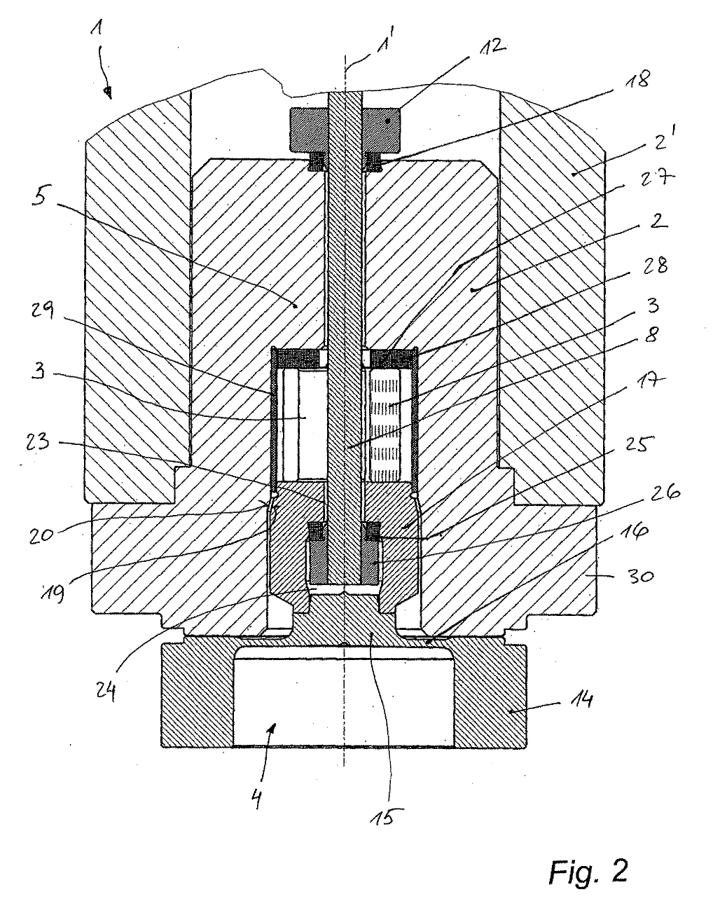

FIG. 2 a pressure sensor according to the invention in axial section with the membrane element undamaged;

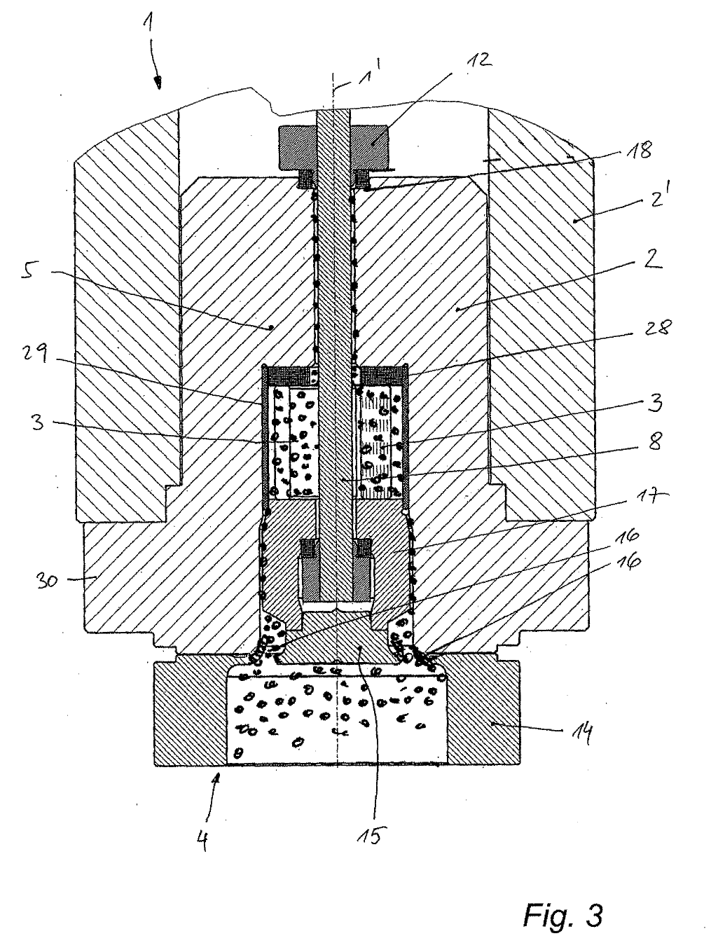

FIG. 3 the pressure sensor according to the invention of FIG. 1 with broken membrane;

FIG. 4 the pressure sensor of FIG. 1 with broken membrane and broken measuring elements; and

FIG. 5 an enlarged detail of FIG. 4.

The state-of-the-art piezoelectric pressure sensor 1 shown in FIG. 1 has piezoelectric measuring elements 3 contained in a housing 2, which are prestressed between a membrane element 4 and the housing base 5. The membrane element 4 with its exterior membrane flange 14 is welded to the pressure-side end of the housing 2. The membrane element 4 has a centered membrane stamp 15 and a thin annular membrane 16, which forms a single piece with the membrane flange 14.

The piezoelectric measuring elements 3 are disposed radially outwards from a prestressing element 8, which extends essentially along the longitudinal sensor axis 1′ and will prestress the piezoelectric measuring elements 3 against the housing base 5. In the same manner in which in two parallel metal plates 3 are positioned in FIG. 1, a plurality of measuring elements may be disposed equidistantly from the prestressing element 8 (see FIGS. 2 to 4), for instance three measuring element plates disposed in a triangular pattern.

The housing 2 may be a multi-part unit, being for instance split along the line T, where the individual housing parts are welded together following assembly of the measuring elements 3.

The piezoelectric measuring elements 3 are provided with an annular pick-up electrode 9 at their smaller sides 6 and an electrically insulating element 10 in the direction of the membrane element 4, an electrically conducting connection being established between the prestressing element 8 and the pick-up electrode 9, such that the centered prestressing element 8 will simultaneously serve as a signal lead. Measurement is relative to the housing ground.

The prestressing element 8 passes through the pick-up electrode 9 and the insulating element 10 via openings 9′ and 10′, with the prestressing element 8 being anchored in the insulating element 10 by a conical flare 11 and stressed against a further insulating element 10 on the end of the sensor housing 2 opposite the housing base 5. The prestressing element 8 is fixed in the stressed position by a fixing element 12, said fixing element 12 being screwed or welded to the prestressing element 8.

The prestressing element 8, which simultaneously serves as signal lead, exits the sensor housing 2 at the end opposite the membrane 4 via an insulating element 13, which may be made of the same ceramic material as the insulating elements 10.

If the sensor is in use in the combustion chamber wall of an internal combustion engine not shown here, and the membrane fails, i.e. the thin annular membrane 16 of the membrane element 4 is destroyed, the membrane stamp 15 might fall into the combustion chamber and cause damage there. Also, hot exhaust gases could enter the interior of the pressure sensor. Prolonged exposure of the measuring elements 3 to hot exhaust gases will cause their destruction, consequently the prestressing element 8 will no longer be supported by the measuring elements 3 and will come loose; in turn the insulating elements 10, 13 will be destroyed. As a consequence hot exhaust gases and flames may escape from the combustion chamber.

The piezoelectric pressure sensor 1 of the invention shown in FIGS. 2 to 5 has the following improvements, which will avoid the damage following membrane failure as described above:
The centered membrane stamp 15 is attached to the pressure body 17, keeping it clear of the combustion chamber of an engine even if the membrane breaks.
The prestressing element 8 is prestressed against the housing base 5 with a gas-tight insulating element 18 being interposed. As shown in FIG. 3, hot exhaust gas (indicated by black dots) can only penetrate as far as the insulating element 18, but cannot escape from the pressure sensor. The system is gas-sealed against the environment even in the case of membrane failure.
The pressure body 17 has a sealing shoulder 19, which upon failure of the membrane 16 and measuring elements 3 (see FIG. 4) will press against a sealing seat 20 inside the housing 2 as soon as the pressure body 17 is moved in the direction of arrow 21 by the pressure in the combustion chamber, thus creating a gas-tight zone.

The situation in the gap 22 between pressure body 17 and the interior wall of housing 2 is shown in detail in FIG. 5. The surfaces of the sealing shoulder 19 and the sealing seat 20 each form an acute angle with the axis 1′ of the pressure sensor 1 and are aligned against each other in such a way that—after the measuring elements 3 have been destroyed—the parts 15 and 17 wedge or grind together under a pressure shock from the combustion chamber.

The centered membrane stamp 15 may be attached to the pressure body 17 for instance by welding, glueing or screwing or by means of a shrink fit.

According to the invention the pressure body 17 has a bore 23, through which the prestressing element 8 passes with play, an insulating disc 25 and a fixing element 26 (for instance a nut) being provided in a recess 24 of the pressure body 17 for holding the prestressing element 8 in place.

On the side facing the housing base 5 the measuring elements 3 contact a thin working electrode 27, which in turn contacts the prestressing element 8 and is insulated against the housing base 5 by an insulating disc 28. On the outer side the measuring elements 3 are enclosed by a cylindrical insulating sleeve 29, for instance made of plastic, which during assembly acts as a centering means.

The housing 2, which sits with play in an outer housing 2′, has a disc-shaped flange 30 which is welded to the membrane flange 14. The individual parts 2, 2′ of the housing are also welded together in the area of the flange. The pressure sensor 1 can be fitted into a measuring bore (not shown here) or screwed into the bore by means of an exterior thread on the outer housing 2′.

1-5. (canceled)

6. A piezoelectric pressure sensor comprising:
a housing defining a housing base and a longitudinal axis,
piezoelectric measuring elements inserted into the housing,
a membrane element disposed on a pressure side of the housing, said membrane element having a membrane stamp being centered in a thin annular membrane,
wherein the piezoelectric measuring elements are radially disposed outwards from a prestressing element extending essentially along the longitudinal axis of the housing, which prestressing element passes through the base of the housing and serves as a lead for the sensor signals and is connected to a pressure body at its end adjacent to the membrane,
wherein the centered membrane stamp is attached to the pressure body, and wherein the prestressing element is prestressed against the housing base with a gas-tight insulating element interposed.

7. The piezoelectric pressure sensor according to claim 6, wherein the pressure body has a sealing shoulder, which upon failure or breakage of the measuring elements will fit against a sealing seat of said housing, thus forming a gas-tight zone.

8. The piezoelectric pressure sensor according to claim 6, wherein the pressure body has a bore for passing through the prestressing element with play, and wherein in a recess on the membrane side of the pressure body an insulating disc and a fixing element are provided to hold the prestressing element in place.

9. The piezoelectric pressure sensor according to claim 6, wherein the measuring elements are contacting a pick-up electrode on the side facing the housing base, said pick-up electrode contacting the prestressing element and being electrically insulated from the housing base by an insulating disc.

10. The piezoelectric pressure sensor according to claim 6, wherein the measuring elements are contained in a cylindrical insulating sleeve.
